(19) United States
(12) Patent Application Publication
(10) Pub. No.: US 2018/0006987 A1
(43) Pub. Date: Jan. 4, 2018

(54) METHOD AND SYSTEM FOR PARTIAL TOPIC UPDATES IN AN IMPROVED DATA DISTRIBUTION SERVICE

(71) Applicants: John Brian Pipe, Allen, TX (US); Swati Mittal, Murphy, TX (US); Alagar Anand Rajendran, Richardson, TX (US)

(72) Inventors: John Brian Pipe, Allen, TX (US); Swati Mittal, Murphy, TX (US); Alagar Anand Rajendran, Richardson, TX (US)

(21) Appl. No.: 15/404,993

(22) Filed: Jan. 12, 2017

Related U.S. Application Data
(60) Provisional application No. 62/357,773, filed on Jul. 1, 2016.

(51) Int. Cl. H04L 12/58

(52) U.S. Cl. CPC H04L 51/16; H04L 51/04

(57) ABSTRACT

Partial updates to an improved DDS are enabled by a framework API that enables different threads to asynchronously access a topic, while maintaining integrity of the topic in the improved DDS. New fields in a topic of the improved DDS may be added by new DDS publishers for the topic without altering the functionality of existing DDS publishers for the topic.

### CROSS-REFERENCE TO RELATED APPLICATION

This application claims priority from U.S. Provisional Application No. 62/357,773 filed Jul. 1, 2016, entitled “Optimization of Networks Carrying Super-Channels with Different Modulation Formats”.

### BACKGROUND

### Field of the Disclosure

The present disclosure relates to communication networks, and more specifically, to methods and systems for partial topic updates in an improved data distribution service.

### Description of the Related Art

A communication network may include network elements that route packets through the network. Some network elements may include a distributed architecture, wherein packet processing may be distributed among several subsystems of the network element (e.g., line cards). Thus, network elements may be modular and may include various sub-systems or sub-elements, which may include a shelf, a slot, a port, a channel and various combinations thereof. Each sub-system may be associated with a different software context, such as an execution thread for embedded software or embedded code that executes on the sub-system.

Accordingly, various software components associated with sub-systems in a network element (or among different network elements) communicate with one another, such as to exchange information, including status updates on hardware components associated with the sub-systems. The software architecture implemented in such network elements may include a data distribution service (DDS) for providing a standard interface to exchange information between ‘publishers’ and ‘subscribers’ using so-called ‘topics’ that in turn are comprised of individual fields. One example of a standard for DDS is promulgated by the Object Management Group (OMG) and defines a standardized exchange of data in a data-driven network architecture (see http://www.omg.org/spec/DDS/1.4/PDF/). In certain instances, a DDS may be incorporated into a network element software architecture as a middleware module having specific pre-defined functionality.

### SUMMARY

In one aspect, a disclosed method is for performing partial topic updates in an improved DDS. The method includes receiving, in an improved data distribution system (DDS), a partial topic update for a topic from a DDS publisher of the topic, the partial topic update consisting of a first field in the topic. In the method, second fields in the topic include all fields in the topic except the first field. In the method, the DDS publisher may be associated with a sub-system of a network element. Responsive to receiving the partial topic update, the method may also include reading the topic from the improved DDS, including the first field and the second fields, to determine a current DDS topic. The method may further include replacing the first field from the current DDS topic with the partial topic update to generate an updated DDS topic. In the method, the second fields in the current DDS topic are not modified. The method may still further include writing the updated DDS topic, including the partial topic update, to the DDS, wherein DDS subscribers to the topic receive the updated DDS topic.

In any of the disclosed embodiments of the method, reading the topic, replacing the first field, and writing the updated DDS topic are performed from a first thread with mutex locking with regard to the topic, where no other thread except the first thread is permitted to access the topic in the improved DDS after reading the topic and prior to writing the updated DDS topic.

In any of the disclosed embodiments of the method, the improved DDS is implemented in a network element. In the method, the topic may be an operational topic indicative of an operational status of the sub-system in the network element. In the method, the topic may include at least one of: events associated with the network element, alarms associated with the network element, and operational data associated with the network element. In the method, the DDS subscribers may include a screen user interface.

In any of the disclosed embodiments of the method, the improved DDS may be implemented in an embedded device.

In any of the disclosed embodiments of the method, the DDS publisher may not be enabled to publish at least some of the second fields in the topic.

Another disclosed aspect includes a network element enabled for performing partial topic updates in data distribution systems, and comprising a processor enabled to access memory media storing instructions executable by the processor to perform any of the embodiments of the method.

A further disclosed aspect includes non-transitory computer readable memory media storing instructions executable by a processor to perform any of the embodiments of the method.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of selected elements of an embodiment of a network;

FIG. 2 is a block diagram of selected elements of DDS functionality;

FIG. 3 is a block diagram of selected elements of an embodiment of a network element software architecture for supporting partial topic updates in an improved DDS;

FIG. 4 is a block diagram of selected elements of an embodiment of an example for supporting partial topic updates in an improved DDS;

FIG. 5 is a flow chart of selected elements of an embodiment of a method for partial topic updates in an improved DDS;

FIG. 6 is a block diagram of selected elements of an embodiment of an example for supporting partial topic updates in an improved DDS; and

FIG. 7 is a block diagram of selected elements of an embodiment of a network element.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, as an example (not shown in the drawings), device “12-1” refers to an instance of a device class, which may be referred to collectively as devices “12” and any one of which may be referred to generically as a device “12”. In the figures and the description, like numerals are intended to represent like elements.

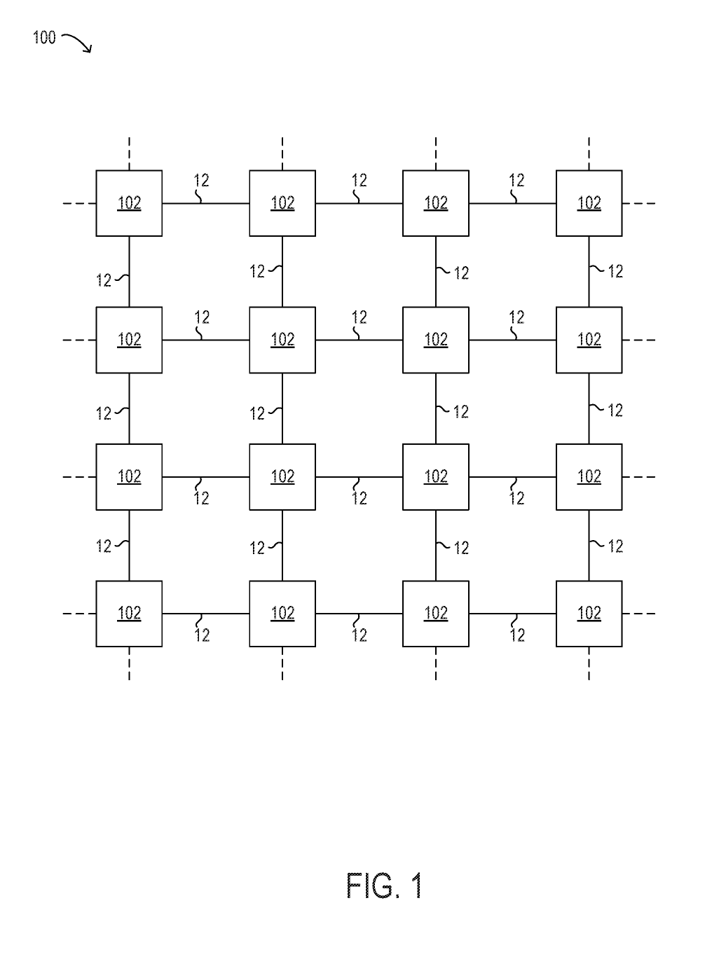

Turning now to the drawings, FIG. 1 is a block diagram showing selected elements of an embodiment of network 100. In certain embodiments, network 100 may be an Ethernet network. Network 100 may include one or more transmission media 12 operable to transport one or more signals communicated by components of network 100. The components of network 100, coupled together by transmission media 12, may include a plurality of network elements 102. In the illustrated network 100, each network element 102 is coupled to four other nodes. However, any suitable configuration of any suitable number of network elements 102 may create network 100. Although network 100 is shown as a mesh network, network 100 may also be configured as a ring network, a point-to-point network, or any other suitable network or combination of networks. Network 100 may be used in a short-haul metropolitan network, a long-haul inter-city network, or any other suitable network or combination of networks.

Each transmission medium 12 may include any system, device, or apparatus configured to communicatively couple network devices 102 to each other and communicate information between corresponding network devices 102. For example, a transmission medium 12 may include an optical fiber, an Ethernet cable, a T1 cable, a WiFi signal, a Bluetooth signal, and/or other suitable medium.

Network 100 may communicate information or “traffic” over transmission media 12. As used herein, “traffic” means information transmitted, stored, or sorted in network 100. Such traffic may comprise optical or electrical signals configured to encode audio, video, textual, and/or any other suitable data. The data may also be transmitted in a synchronous or asynchronous manner, and may be transmitted deterministically (also referred to as ‘real-time’) and/or stochastically. In particular embodiments, traffic may be communicated via a suitable communications protocol, including, without limitation, the Internet Protocol (IP). Additionally, the traffic communicated via network 100 may be structured in any appropriate manner including, but not limited to, being structured in frames, packets, or an unstructured bit stream.

Each network element 102 in network 100 may comprise any suitable system operable to transmit and receive traffic. In the illustrated embodiment, each network element 102 may be operable to transmit traffic directly to one or more other network elements 102 and receive traffic directly from the one or more other network elements 102.

Modifications, additions, or omissions may be made to network 100 without departing from the scope of the disclosure. The components and elements of network 100 described may be integrated or separated according to particular needs. Moreover, the operations of network 100 may be performed by more, fewer, or other components.

As noted above, network elements 102 may be modular and may include various sub-systems or sub-elements, such as a shelf, a slot, a port, a channel and various combinations thereof. Each sub-system or sub-element may be associated with a different software context, such as an execution thread for embedded software or embedded code that executes on the sub-system. Accordingly, network elements 102 may include corresponding processors and memory media for executing instructions to implement the different software contexts. Thus, the overall application software executing on a network element 102 may be comprised of different threads that execute asynchronously and at different individual controllers or processors, which are linked together within network element 102 by an internal network or bus. Additionally, the network element 102, or network 100, may communicate with a user interface application that enables a user, such as a network administrator, to monitor and control the operation and functionality of network elements 102, including monitoring and controlling the sub-elements and sub-components.

In order to facilitate communication of information, such as status and measurements associated with the individual the sub-elements and sub-components, a data distribution service (DDS) may be incorporated into the software architecture of network element 102. The DDS may be a middleware product that complies with an industry standard, such as promulgated by OMG in one example, while other DDS implementations may also be used in different embodiments. As such, the DDS system may be provided with certain fixed functionality for data distribution, but may have certain disadvantages, particularly when used in the network element software architecture. For example, the DDS may only support full topic updates, while different contexts of the application software on network element 102 may only be enabled to provide certain fields for a topic and not a full topic, because the topic fields may be associated with different sub-elements of network element 102 having their own execution thread.

In operation, as will be described in further detail herein, network elements 102 in network 100 may be enabled to support partial topic updates using an improved DDS, as disclosed herein. Specifically, a framework in the network element software architecture may provide a common application programming interface (API) for the application software used in network element 102. The framework API may include standardized functions available to the application software. The standardized functions in the framework API may include encapsulated functions to access the improved DDS. Additionally, the standardized functions in the framework API may be adapted to receive partial topic updates that are administered by the improved DDS, which may incorporate aspects of a standardized DDS, even when the standardized DDS used does not support partial topic updates. The framework API may accordingly receive a partial topic update, read the full topic from the improved DDS, swap the fields in the partial topic update from the topic, and write back the full topic to the DDS. The framework API may rely upon mutex locking to ensure integrity of the topics in the improved DDS. The framework API is implemented in a manner that is agnostic of topic type and topic fields for any topic and can work generically for any topic with any fields. The framework API can accordingly be used with new fields added to topics without any software modifications, which is desirable.

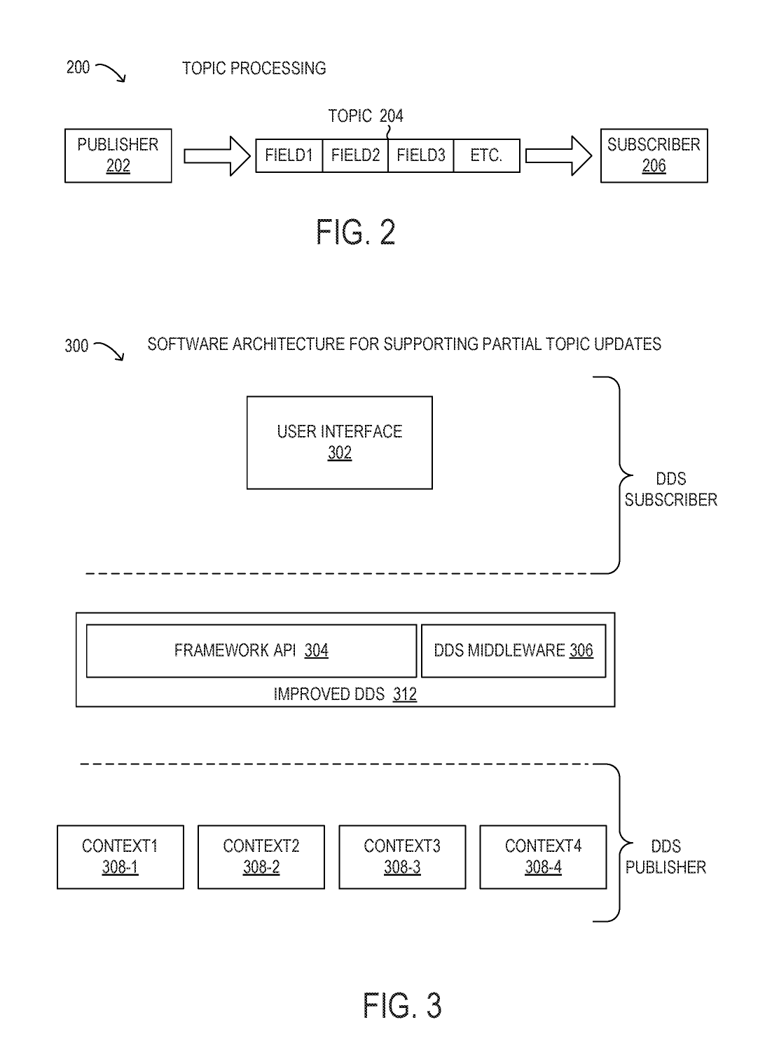

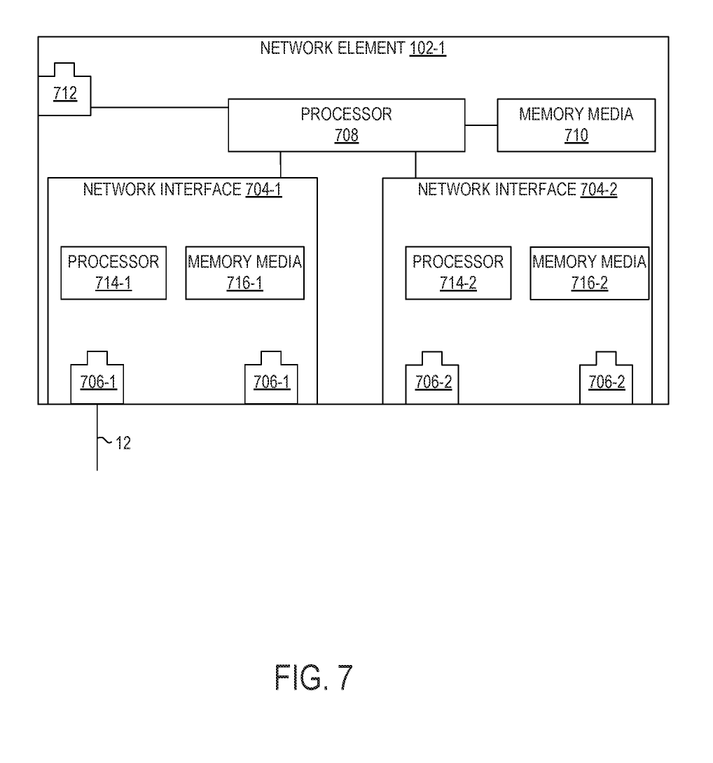

Referring now to FIG. 2, a block diagram of selected elements of topic processing 200 in a DDS is shown. Topic processing 200, as shown, comprises information in the form of a topic 204 that is generated by a publisher 202 and is received by a subscriber 206. Various entities in the software architecture may be publishers 202 and subscribers 206 for a given topic 204. In some embodiments, publishers 202 and subscribers 206 may be sub-elements in a network element 102, such as a shelf, a slot, a port, a channel and various combinations thereof. For example, different publishers 202 may execute in a different software context, such as an execution thread for embedded software on a sub-system of network element 102 (see also FIG. 7). Topic 204 itself may be comprised of a plurality of individual fields, representing atomic units of information. The DDS may provide defined functionality to manage the processes of creating and deleting subscribers 206 and publishers 202, updating and maintaining topics 204, and expanding any given system over time. Thus, the use of a standardized DDS may enable a reduction in software complexity for software to be developed in the network element software architecture, which is desirable.

However, as noted, a standardized DDS may not support partial topic updates, in which some fields in topic 204 are generated by given publisher 202, while other fields are not (or cannot be) generated by the given publisher 202. The need for partial topic updates arises in the network element software architecture, because the sub-systems of network element 102 may each be DDS publishers 202 while executing in different contexts (or execution threads). As a result, the management of individual topics may become complex and may lead to customizations in the software architecture that are resource-intensive to perform and to maintain over time, and are, therefore, undesirable. Accordingly, an improved DDS with a framework API for supporting partial topic updates is disclosed herein. The improved DDS may support topic processing 300 with partial topic updates, as described herein.

Referring now to FIG. 3, a diagram depicts selected elements of an embodiment of a software architecture 300 for supporting partial topic updates, as disclosed herein. Specifically, in FIG. 3, software architecture 300 illustrates execution of a framework API 304 that enables partial topic updates in an improved DDS 312. It is noted that software architecture 300 may be an example of a data-driven network architecture in which the modules and elements presented therein may be distributed over any given network or network system, including network 100. Software architecture 300 may be executed in a network environment. In various embodiments, software architecture 300 may be for execution on a network element, such as network element 102 in network 100 (see FIG. 1). It is noted that certain portions of software architecture 300 may be executed on an embedded device, such as an electronic device including a processor with access to memory media storing instructions executable by the processor.

In software architecture 300, DDS publishers are shown in the lower portion of FIG. 3 as application modules 308 from CONTEXT1 308-1, CONTEXT2 308-2, CONTEXT3 308-3, and CONTEXT4 308-4, shown as generic examples of application modules 308. Each DDS publisher may be associated with a partial topic (some but not all fields in a topic). As shown, improved DDS 312 includes framework API 304 and DDS middleware 306. In various embodiments, DDS middleware 306 may represent standard DDS functionality. Framework API 304 may include the application framework and may access DDS middleware 306 to support certain standardized DDS functions. Framework API 304 may also support partial topic updates in improved DDS 312. For example, framework API 304 may be specially adapted to receive a partial topic update from a given publisher, read the full topic under mutex locking, swap only the fields in the topic provided with the partial topic update, and then write the full topic back to improved DDS 312 using DDS middleware 306. At the top level of software architecture 300 is a user interface 302 that is a DDS subscriber to the topics and may enable a user to view the topics in real time, such as for monitoring and control of network 100.

It is noted that software architecture 300 may provide various advantages. For example, software architecture 300 is not dependent on any given data model, such as the types, lengths, or formats of any given topic. Software architecture 300 allows application software in any context to process individual topic fields asynchronously and independently of one another. Publishing of one topic field may be separated from the publishing of another topic field in the same topic. New fields that may be later added to a topic in a change of the data model may be accommodated without relying on changes to the existing software already associated with the topic, such as existing DDS publishers. For example, when DDS middleware 306 includes Google Protocol Buffers to access topic messages, framework API 304 may be able to iterate over fields in any given topic and access or manipulate the values in the fields without having to specify any specific message type. Accordingly, framework API 304 may be agnostic to any given topic and the number and type of fields contained therein.

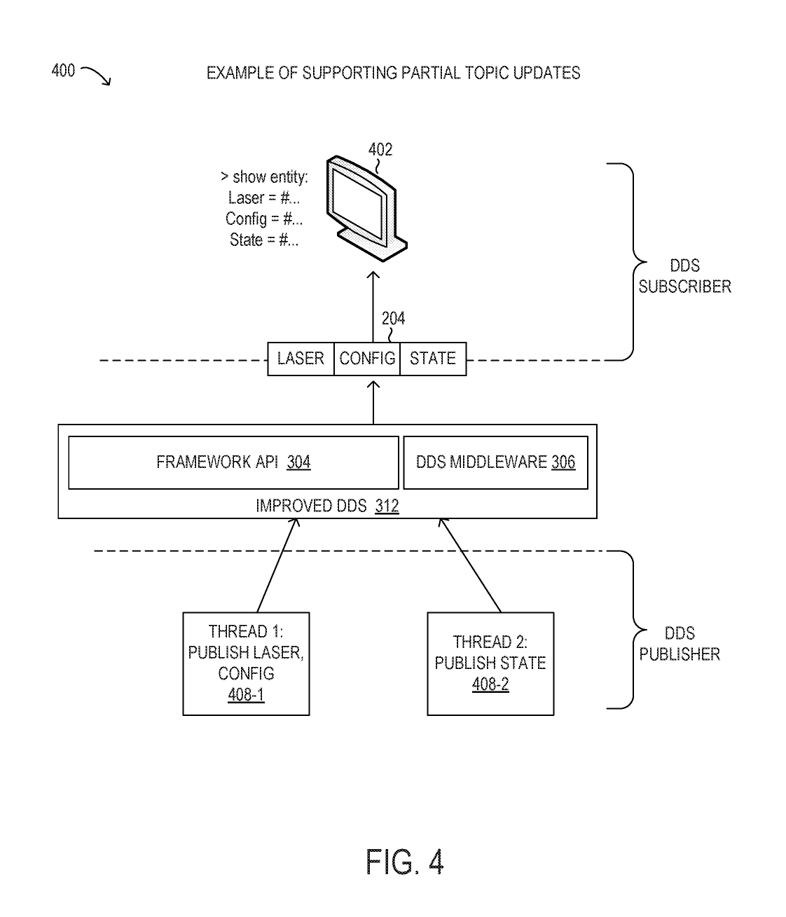

Referring now to FIG. 4, a diagram depicts selected elements of an embodiment of a software example 400 for execution on a network element, such as network element 102 (see FIG. 1) for supporting partial topic updates, as disclosed herein. Software example 400 is presented as an example to show an implementation of software architecture 300 (see FIG. 3). In software example 400, topic 204 consisting of 3 fields (LASER, CONFIG, STATE) is shown. At the application software layer, Thread1 408-1 and Thread2 408-2 represent different DDS publishers. Thread1 408-1 is enabled to publish fields LASER and CONFIG, while Thread2 is enabled to publish the STATE field of topic 204. At the top layer, a user application 402 provides the entire topic to a user using the DDS implemented in framework API 304, shown included in improved DDS 312 along with DDS middleware 306. Accordingly, framework API 304 is enabled to receive partial topic updates from both Thread1 408-1 and Thread2 408-2, and provide the full updated topic to user application 402 as the DDS subscriber. Accordingly, user application 402 may query topic 204, and receive a complete response with all the fields in topic 204 being updated to the most current values, as supplied asynchronously to framework API 304 by Thread1 408-1 and Thread2 408-2. User application 402 may include a screen user interface that represents a textual or graphical user interface for inputting information and receiving and displaying output information. In various embodiments, the screen user interface may be a command line interface (CLI) or a graphical user interface (GUI).

Another important feature of the methods and systems for partial topic updates in an improved DDS described herein is the implications for software maintenance. For example, as software example 400 is used over time, changes may be made to the topics in the improved DDS. For example, new topics may be added, or new fields may be added to an existing topic. However, because of partial topic updates supported by improved DDS 312, as fields are added to existing topics in improved DDS 312, existing DDS publishers 408 may remain unchanged with respect to their topic and field publishing functionality, and still operate with improved DDS 312. Even when a particular DDS publisher 408 previously performed a full topic update, but now performs a partial topic update because fields have been added to the topic, the DDS publisher 408 will still operate correctly without modification going forward, which is desirable because of the improved flexibility and reliability of the software that is achieved by not having to make modifications to existing software (which can be significant and substantial) as fields or topics are added in improved DDS 312.

The topic and fields shown in software example 400 may be referred to as so-called “operational topics”, which are used to communicate “operational data” indicative of various aspects of a current operational status of hardware components and connections between components included in network element 102, or included in another target platform of improved DDS 312.

The operational topics may include state of a given component (or entity), such as an optical interface, an Ethernet interface, a pluggable interface card (line card), and other similar components or entities. The state of the component may include general in-service or out-of-service properties (typically referred to as a “primary state”). The state of the component may also encompass properties that are determined by a condition or quality of the telecommunication signals transmitted (typically referred to as a “secondary state”). For example, a communication signal may be in an alarm state, or a given component may be out-of-service because another component on which the given component depends is out-of-service. In another example, a component could be out-of-service because a hardware element included in the component exhibits a fault. These exemplary state-related properties, among others, may be communicated using operational topics.

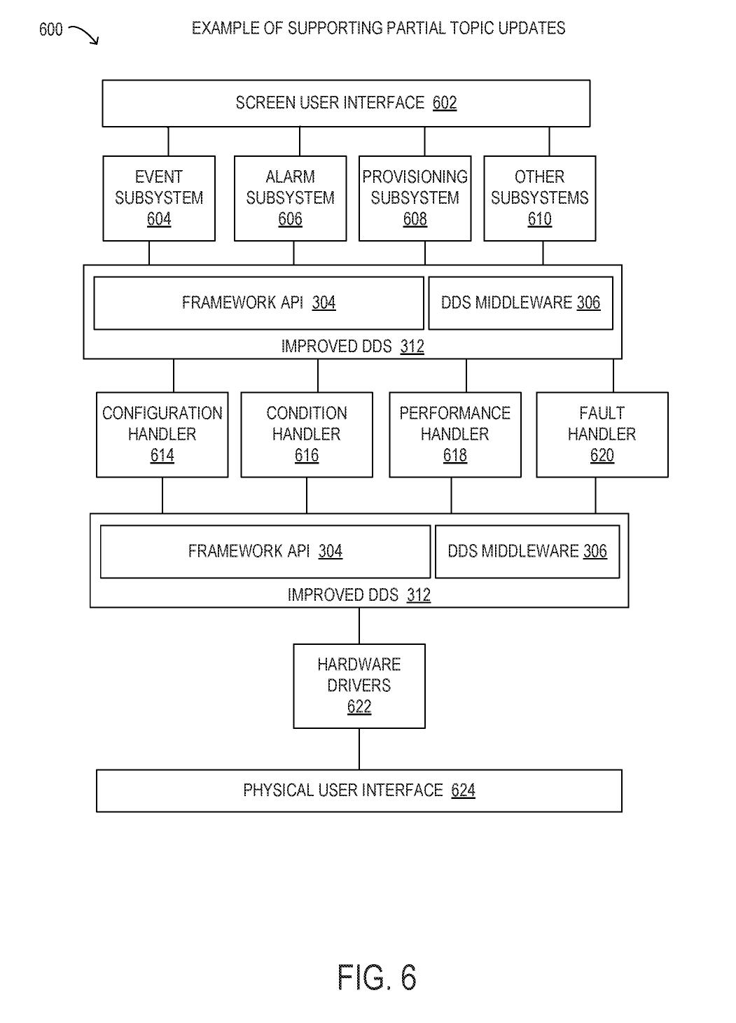

The operational topics may include various different hardware values, hardware settings, or hardware attributes that are displayed by user application 402, and which may be different for different components or entities. Thus, the operational topics may include trace messages (textual or numeric messages) that can be inserted into network traffic signals, such as by an end user in order to ensure that the network signals are connected properly from a sender to a receiver of the signals. The operational topics may also include trace messages that have been received in a network element. For example, the insertion of trace messages may be communicated from provisioning subsystem 608 to configuration handler 614 (see FIG. 6), while the retrieval of trace messages may be communicated via operational topics communicated from one or more handlers to provisioning subsystem 608, and then displayed to the user when requested.

The operational topics may describe provisioning attributes that certain hardware has been instructed to determine itself. One example of a provisioning attributes is the auto-negotiation feature that is specified in the Ethernet standard. When the auto-negotiation feature is enabled, the hardware (an Ethernet port) will negotiate the speed and duplex settings for an Ethernet connection based on the settings that are communicated from the hardware (Ethernet port) at the other end of the Ethernet connection. The operational topics may include various settings, such as auto-negotiation, which may be read and communicated using operational topics to enable users to have access to the settings via the operational topics.

The operational topics may include various types of calculations. For example, certain values may be calculated in low-level hardware or software layers, such as a spanloss value for reconfigurable optical add drop multiplexer (ROADM) network optical signals. Values, such as spanloss values, may be communicated using operational topics to enable users to have access to the values via the operational topics.

The operational topics may include other values such as incoming wavelengths for fiber optic signals, quality levels values, clockmode settings, signal labels (a value that communicates what kind of payload is carried over a customer traffic signal), among other examples.

The operational topics may include internal communications are not displayed by user application 402, but are internally used in certain software components. Some examples of internal communication include: a current shelf number, an IP address and a MAC address for a physical interface, a reason for the most recent system restart, firmware information for pluggable interface cards, among other internal information.

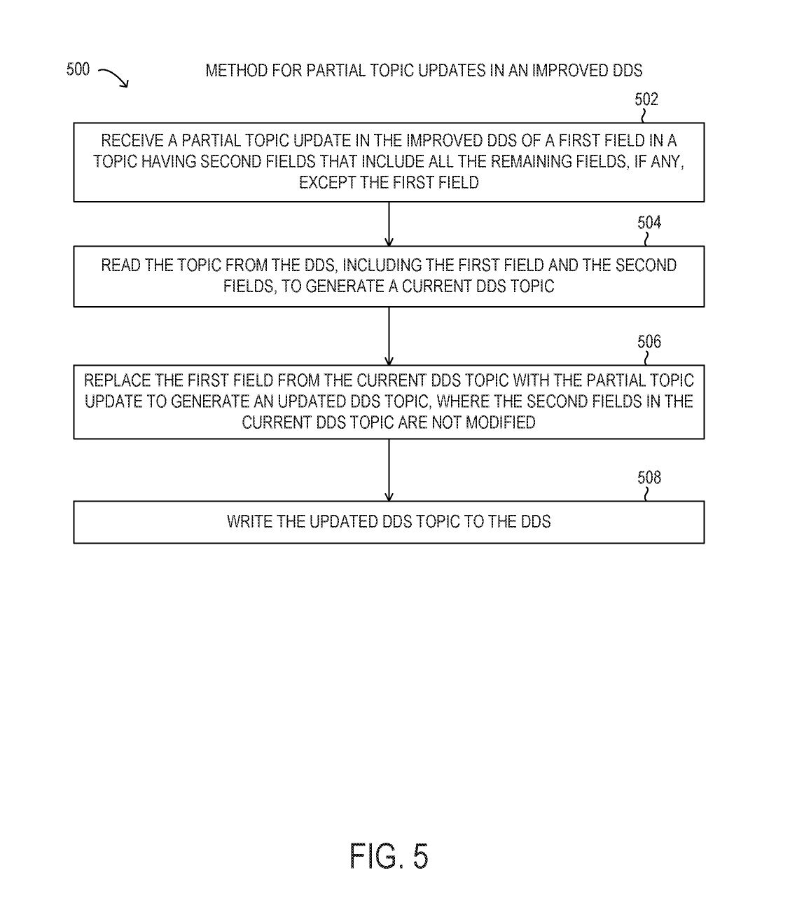

Referring now to FIG. 5, a flow chart of selected elements of an embodiment of a method 500 for partial topic updates in an improved DDS, as described herein, is depicted in flowchart form. Method 500 may be performed using network element 102, such as by a processor in network element 102 enabled to access memory storing instructions to perform method 500. It is noted that certain operations described in method 500 may be optional or may be rearranged in different embodiments.

Method 500 may begin at step 502 by receiving a partial topic update in the improved DDS of a first field in a topic having second fields that include all the remaining fields, if any, except the first field. In some embodiments, the partial topic update includes a plurality of first fields, while the second fields include all the remaining fields in the topic except the first fields. At step 504, the topic is read from the DDS, including the first field and the second fields, to generate a current DDS topic. At step 506, the first field from the current DDS is replaced with the partial topic update to generate an updated DDS topic, where the second fields in the current DDS topic are not modified. At step 508, the updated DDS topic is written to the DDS.

Referring now to FIG. 6, a diagram depicts selected elements of an embodiment of a software architecture 600 for supporting partial topic updates, as disclosed herein. Specifically, in FIG. 6, software architecture 600 illustrates execution of a framework API 304 that enables partial topic updates in improved DDS 312. It is noted that software architecture 300 may be an example of a data-driven network architecture in which the modules and elements presented therein may be distributed over any given network or network system, including network 100. Software architecture 600 may be executed in a network environment. In various embodiments, software architecture 600 may be for execution on a network element, such as network element 102 in network 100 (see FIG. 1). It is noted that certain portions of software architecture 600 may be executed on an embedded device, such as an electronic device including a processor with access to memory media storing instructions executable by the processor. In particular embodiments, software architecture 600 may be executed on one or more processors included with network element 102 (see also FIG. 7).

In FIG. 6, improved DDS 312 includes framework API 304 and DDS middleware 306, as described above. Two instances of improved DDS 312 are shown in software architecture 600 to illustrate how various subsystems and handlers can use improved DDS 312 to exchange information and messages, such as partial topic updates.

In software architecture 600 shown in FIG. 6, a screen user interface 602 may represent a textual or graphical user interface for inputting information and receiving and displaying output information. In various embodiments, screen user interface 602 may be a command line interface (CLI) or a graphical user interface (GUI). An event subsystem 604 may send events to screen user interface 602. Events are notifications to the user concerning a state of the network environment, such as a particular network element in network 100, or concerning traffic carried by the network environment, such as errors related to a given signal transmitted by the network environment. As such, events may be topics in improved DDS 312. Events may be transient occurrences that are not normally recorded and are not available for later retrieval, unless an event history log actively records the events. An alarm subsystem 606 may send alarms to screen user interface 602. Alarms may indicate a persistent condition in network environment that indicates some level of user intervention. Thus, an alarm may be considered a user notification that invokes the user to take some action to clear the alarm. As such, alarms may be topics in improved DDS 312. Typically, alarms are stored and can be retrieved at a later time. A provisioning subsystem 608 may receive provisioning commands via screen user interface 602, may validate provisioning rules, may store information in a database, and may publish provisioning topics as a DDS publisher. As shown, other subsystems 610 may represent any of a variety of smaller subsystems, such as those for security authentication, logging, provisioning automation, database management, firmware download, among other functions, which may be associated with a variety of topics in improved DDS 312.

Also shown in software architecture 600 in FIG. 6, a configuration handler 614 may be a DDS subscriber in improved DDS 312 for provisioning topics. Configuration handler 614 may performs certain actions for getting hardware drivers 622 configured properly to support physical user interface 624. A condition handler 616 may receive raw alarm data via hardware drivers 622 from the underlying hardware and may convert the raw alarm data to alarms. Thus, condition handler 616 may be a DDS publisher for alarm topics, while alarm subsystem 606 may be a DDS subscriber for alarm topics. Condition handler 616 may also be a DDS publisher for event topics, while event subsystem 604 may be a DDS subscriber for event topics. Performance handler 618 may maintain various counters that indicate the number of errors detected in the network traffic transmitted over the network environment over certain periods of time. Performance handler 618 may accordingly be a DDS publisher for events that indicate when certain counter thresholds are crossed, for example. Fault handler 620 may be responsible for taking action when various alarms are detected. The action taken by fault handler 620 may include switching network signals over a given network path, for example. Accordingly, fault handler 620 may be a DDS subscriber for alarm topics.

At the bottom of FIG. 6, hardware drivers 622 may provide interfaces to hardware components that control electrical signals and optical signals, such as in network elements 102 or in other target platforms for improved DDS 312. Also, hardware drivers 622 may support operation of physical user interface 624, which may include various controls (input, display) and indicators (display), such as switches, buttons, dials, knobs, numerical displays, indicator lights, etc.

As noted above with respect to FIG. 4, software architecture 600 in FIG. 6 may use operational topics. The operational topics may represent information that is send upwards in FIG. 6, or is send sidewards within a given level shown in FIG. 6. Various examples of upward moving operational topics, which are typically involved with displaying information to a user at screen user interface 602, are described above with respect to FIG. 4. The sideward communicated operational topics may be used to communicate operational topics among software component. Operational topics may be currently stored in memory and may be updated in real-time to provide up-to-date current topics and fields.

Referring now to FIG. 7, a block diagram of selected elements of an embodiment of network element 102-1, which is represented as a particular embodiment of network elements 102 (see FIG. 1) for descriptive purposes, is illustrated. Network element 102-1, as shown, includes processor 708 and memory media 710, and external port 712, along with network interface 704-1 having ports 706-1 and network interface 704-2 having ports 706-2. External port 712 may be used by processor 708 to communicate with neighbor network elements (see FIG. 1).

As depicted in FIG. 2, each network element 102 may include processor 708 and memory media 710 that may store instructions executable by processor 708. Processor 708 may include a single processing unit (e.g., a core) or may include multiple processing units (not shown). In certain embodiments, processor 708 may represent a multi-processor subsystem in which each individual processor includes one or more processing units. The individual processors or processing units may provide processing resources, such as a processing frequency, messaging, instruction queuing, memory caching, virtual memory, among others, to process instructions and code. As shown, memory media 710 may represent volatile, non-volatile, fixed, and/or removable media, and may be implemented using magnetic and/or semiconductor memory. Memory media 710 is capable of storing instructions (i.e., code executable by processor 708) and/or data. Memory media 710 or at least a portion of contents of memory media 710 may be implemented as an article of manufacture comprising non-transitory computer readable memory media storing processor-executable instructions. Memory media 710 may store instructions including an operating system (OS), which may be any of a variety of operating systems, such as a UNIX variant, LINUX, a Microsoft Windows® operating system, or a different operating system.

In FIG. 2, network elements 102 are shown including at least one network interface 704, which provides a plurality of ports 706 that receive a corresponding transmission media 12 (see also FIG. 1). Ports 706 and transmission media 12 may represent galvanic or optical network connections. Each network interface 704 may include any suitable system, apparatus, or device configured to serve as an interface between a network element 102 and transmission medium 12. Each network interface 704 may enable its associated network element 102 to communicate with other network elements 102 using any of a variety of transmission protocols and/or standards. Network interface 704 and its various components may be implemented using hardware, software, or any combination thereof. In certain embodiments, network interfaces 704 may include a network interface card. In various embodiments, network interfaces 704 may include a line card. Each port 706 may include a system, device or apparatus configured to serve as a physical interface between corresponding transmission medium 12 and network interface 704. In some embodiments, port 706 may comprise an Ethernet port. Although in FIG. 2 network interfaces 704 are shown with 2 instances of ports 706 for descriptive clarity, in different embodiments, network interfaces 704 may be equipped with different numbers of ports 706 (e.g., 4, 6, 8, 16 ports, etc.).

As shown in FIG. 2, network interfaces 704 may include respective processors 714 and memory media 716, which may store and execute instructions and may be implemented in a similar manner as described above with respect to processor 708 and memory media 710, respectively. In various embodiments, processors 714 may execute internal instructions and operations, such as for implementing improved DDS 312 disclosed herein, and may be under control or supervision of processor 708. Furthermore, processor 708 and processor(s) 714, along with various internal and external network ports included in network element 102, may represent at least one local network domain that is configured at network element 102.

In various embodiments, network element 102 may be configured to receive data and route such data to a particular network interface 704 or port 706 based on analyzing the contents of the data or based on a characteristic of a signal carrying the data (e.g., a wavelength or modulation of the signal). In certain embodiments, network element 102 may include a switching element (not shown) that may include a switch fabric (SWF).

As noted previously, network element 102 may implement and execute improved DDS disclosed herein. For example, memory media 710 may store instructions corresponding to DDS middleware 306 and framework API 304. In some embodiments, memory media 710, memory media 716, or both may store instructions to implement a DDS publisher 202 or a DDS subscriber 206 (see FIG. 2). Also, network interface 704 or port 706 may represent a sub-system of network element 102, among other sub-systems, such as a shelf, a slot, a channel or various combinations thereof. Each sub-system included in network element 102 may be associated with a DDS subscriber or a DDS publisher or both.

As disclosed herein, partial updates to an improved DDS are enabled by a framework API that enables different threads to asynchronously access a topic, while maintaining integrity of the topic in the improved DDS. New fields in a topic of the improved DDS may be added by new DDS publishers for the topic without altering the functionality of existing DDS publishers for the topic.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for performing partial topic updates in data distribution systems, the method comprising:
receiving, in an improved data distribution system (DDS), a partial topic update for a topic from a DDS publisher of the topic, the partial topic update consisting of a first field in the topic, wherein second fields in the topic include all fields in the topic except the first field, and wherein the DDS publisher is associated with a sub-system of a network element;
responsive to receiving the partial topic update, reading the topic from the improved DDS, including the first field and the second fields, to obtain current field values of the topic;
replacing the first field from the topic with the partial topic update to generate an updated DDS topic, wherein the second fields in the topic are not modified; and
writing the updated DDS topic, including the partial topic update, to the improved DDS, wherein DDS subscribers to the topic receive the updated DDS topic.

2. The method of claim 1, wherein reading the topic, replacing the first field, and writing the updated DDS topic are performed from a first thread with mutex locking with regard to the topic, wherein no other thread except the first thread is permitted to access the topic in the improved DDS after reading the topic and prior to writing the updated DDS topic.

3. The method of claim 1, wherein the improved DDS is implemented in the network element.

4. The method of claim 1, wherein the topic is an operational topic indicative of an operational status of the sub-system in the network element.

5. The method of claim 4, wherein the topic includes at least one of:
events associated with the network element;
alarms associated with the network element; and
operational data associated with the network element, and
wherein the DDS subscribers include a screen user interface.

6. The method of claim 1, wherein the DDS publisher is not enabled to publish at least some of the second fields in the topic.

7. A network element enabled for performing partial topic updates in data distribution systems, the network element comprising:
a processor enabled to access memory media storing instructions executable by the processor to:
receive, in an improved data distribution system (DDS), a partial topic update for a topic from a DDS publisher of the topic, the partial topic update consisting of a first field in the topic, wherein second fields in the topic include all fields in the topic except the first field, and wherein the DDS publisher is associated with a sub-system of the network element;
responsive to receiving the partial topic update, read the topic from the improved DDS, including the first field and the second fields, to obtain current field values of the topic;
replace the first field from the topic with the partial topic update to generate an updated DDS topic, wherein the second fields in the topic are not modified; and
write the updated DDS topic, including the partial topic update, to the improved DDS, wherein DDS subscribers to the topic receive the updated DDS topic.

8. The network element of claim 7, wherein the instructions to read the topic, replace the first field, and write the updated DDS topic are performed from a first thread with mutex locking with regard to the topic, wherein no other thread except the first thread is permitted to access the topic in the improved DDS after reading the topic and prior to writing the updated DDS topic.

9. The network element of claim 7, wherein the topic includes at least one of:
events associated with the network element;
alarms associated with the network element; and
operational data associated with the network element, and
wherein the DDS subscribers include a screen user interface.

10. The network element of claim 7, wherein the improved DDS is implemented in an embedded device included in the network element.

11. The network element of claim 7, wherein the topic is an operational topic indicative of an operational status of the sub-system in the network element.

12. The network element of claim 7, wherein the DDS publisher is not enabled to publish at least some of the second fields in the topic.

13. A non-transitory computer readable memory media storing instructions executable by a processor to:
receive, in an improved data distribution system (DDS), a partial topic update for a topic from a DDS publisher of the topic, the partial topic update consisting of a first field in the topic, wherein second fields in the topic include all fields in the topic except the first field, and wherein the DDS publisher is associated with a sub-system of a network element;
responsive to receiving the partial topic update, read the topic from the improved DDS, including the first field and the second fields, to obtain current field values of the topic;
replace the first field from the topic with the partial topic update to generate an updated DDS topic, wherein the second fields in the topic are not modified; and
write the updated DDS topic, including the partial topic update, to the improved DDS, wherein DDS subscribers to the topic receive the updated DDS topic.

14. The memory media of claim 13, wherein the instructions to read the topic, replace the first field, and write the updated DDS topic are performed from a first thread with mutex locking with regard to the topic, wherein no other thread except the first thread is permitted to access the topic in the improved DDS after reading the topic and prior to writing the updated DDS topic.

15. The memory media of claim 13, wherein the improved DDS is implemented in the network element.

16. The memory media of claim 13, wherein the improved DDS is implemented in an embedded device.

17. The memory media of claim 13, wherein the topic includes at least one of:
events associated with the network element;
alarms associated with the network element; and
operational data associated with the network element, and
wherein the DDS subscribers include a screen user interface.

18. The memory media of claim 13, wherein the topic is an operational topic indicative of an operational status of the sub-system in the network element.

19. The memory media of claim 13, wherein the DDS publisher is not enabled to publish at least some of the second fields in the topic, and wherein the DDS subscribers include a screen user interface.
